(19) United States
(12) Patent Application Publication
(10) Pub. No.: US 2016/0090915 A1
(43) Pub. Date: Mar. 31, 2016

(54) INLET DOOR CONTROL FOR STARTUP OF GAS TURBINE ENGINE

(71) Applicant: UNITED TECHNOLOGIES CORPORATION, Hartford, CT (US)

(72) Inventors: Eric L. Wolff, Encinitas, CA (US); Brent L. Sherill, El Cajon, CA (US); Andre M. Ajami, Spring Valley, CA (US); Kenneth W. Winston, San Diego, CA (US); Victor Pascu, San Diego, CA (US); Phillip Vessa, Thousand Oaks, CA (US); Nelson DaCunha, Avon, CT (US)

(73) Assignee: United Technologies Corporation, Hartford, CT (US)

(21) Appl. No.: 14/787,068

(22) PCT Filed: Apr. 30, 2014
(86) PCT No.: PCT/US2014/036087

§ 371 Date: Oct. 26, 2015

Related U.S. Application Data
(60) Provisional application No. 61/821,885, filed on May 10, 2013.

(51) Int. Cl. F02C 7/268; F02C 7/04

(52) U.S. Cl. CPC F02C 7/268; F02C 7/04; F05D 2220/50; F05D 2260/85

(57) ABSTRACT

A gas turbine engine inlet door control system includes an actuator, an engine controller and a door controller. The actuator opens and closes an inlet door of a gas turbine engine. The engine controller determines an intermediate door position based upon one or more engine start factors. The door controller operates the actuator to open the inlet door to the intermediate door position based on the one or more engine start factors.

### CROSS-REFERENCE TO RELATED APPLICATION(S)

This application claims the benefit of PCT application PCT/US2014/036087, filed Apr. 30, 2014, for “INLET DOOR CONTROL FOR STARTUP OF GAS TURBINE ENGINE” by Eric L. Wolff, Brent L. Sherill, Andre M. Ajami, Kenneth W. Winston, Victor Pascu, Phillip Vessa, and Nelson DaCunha, and U.S. Provisional Application No. 61/821,885, filed May 10, 2013, for “INLET DOOR CONTROL FOR STARTUP OF GAS TURBINE ENGINE” by Eric L. Wolff, Brent L. Sherill, Andre M. Ajami, Kenneth W. Winston, Victor Pascu, Phillip Vessa, and Nelson DaCunha.

### BACKGROUND

The present invention relates to inlet doors for gas turbine engines, and in particular to a system and method for controlling an inlet door during startup of an auxiliary power unit (APU) based upon aircraft flight conditions.

Gas turbine engines, and more specifically APUs, represent a class of engines used to generate kinetic and pneumatic energy. They are employed in a variety of applications, from ground-based power generators to aeronautical applications.

Starting an APU requires the engine to be motored to a certain speed such that the fuel-air mixture provided to the combustor is conducive to light-off (i.e., successful ignition of the engine). These conditions become much more difficult to achieve when at high altitude. For example, if an aircraft is flying at 40,000 feet, there will be very little air flowing through the engine, and the air that is flowing through the engine will be traveling at fairly high velocities. This makes it very difficult to start an APU, or any gas turbine engine at high altitudes.

The APU inlet door is located on the outer skin of the aircraft (e.g. near the tail cone of the aircraft) and is opened to provide airflow to the engine for startup and self-sustaining operation. Traditionally, startup of the APU is done with the APU door fully open. If the APU is started in-flight, having the inlet door fully open can cause air to move through the APU at high velocity. Thus, problems such as wind-milling, or too high of a delta pressure profile across the APU can occur when starting the APU in flight. It is desirable to provide a proper balance air velocity and volume to the APU during in-flight startup.

### SUMMARY

A gas turbine engine inlet door control system includes an actuator, an engine controller and a door controller. The actuator opens and closes an inlet door of a gas turbine engine. The engine controller determines an intermediate door position based upon one or more engine start factors. The door controller operates the actuator to open the inlet door to the intermediate door position based on the one or more engine start factors.

### BRIEF DESCRIPTION OF THE DRAWINGS

FIG. 1 is a block diagram illustrating a system for controlling an inlet door according to an embodiment.

FIG. 2 is a flowchart illustrating a process flow for starting a gas turbine engine in flight according to an embodiment.

FIG. 3 is a flowchart illustrating a method for controlling an inlet door according to an embodiment.

FIG. 4 is a flowchart illustrating a process flow of controlling an inlet door of a gas turbine engine according to an alternate embodiment.

### DETAILED DESCRIPTION

The present invention relates to a system and method for controlling an inlet door for a gas turbine engine, and in particular to a system and method for controlling an inlet door for an auxiliary power unit (APU) during startup. The system includes an APU with an inlet door, an APU controller, an inlet door controller, and an inlet door actuator. The door controller and actuator operate to open the inlet door to an intermediate position between fully closed and fully opened prior to cranking the APU. The intermediate position is determined based upon a number of APU start factors including one or more flight conditions sent to the APU controller from the aircraft, APU conditions, and other factors such as time, air temperature, altitude, air speed, volume of airflow entering the inlet duct, air pressure, the content of oxygen entering the inlet door, etc. In an embodiment, these APU start factors may be measured external to the APU and include, for example, temperature, wind conditions, mach number and altitude. After the engine has started, the inlet door may be opened from the intermediate position to an optimal position and remain there during operation of the APU.

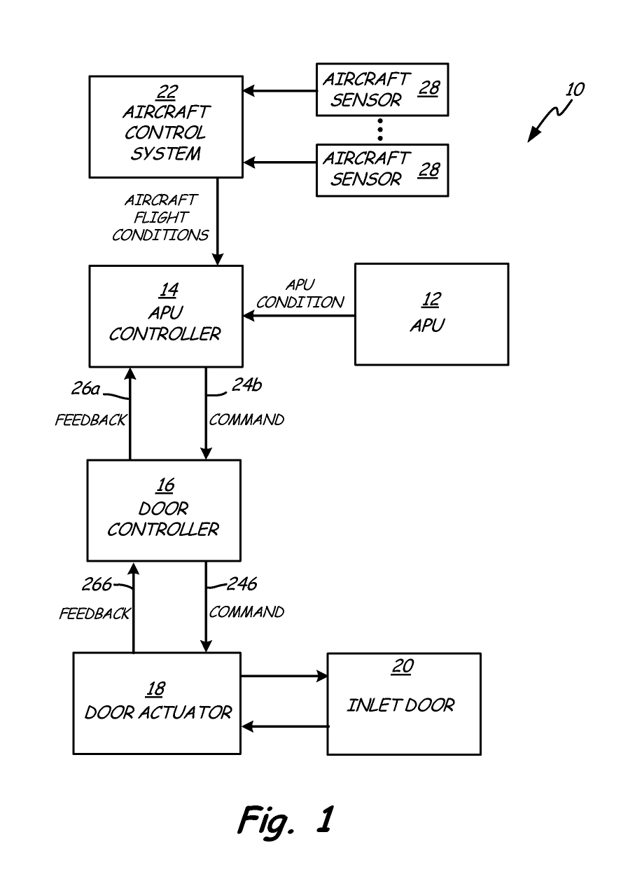

FIG. 1 is a block diagram illustrating a system 10 for controlling an inlet door for an APU. System 10 includes APU 12, APU controller 14, door controller 16, door actuator 18, inlet door 20, aircraft control system 22, command lines 24a and 24b, feedback lines 26a and 26b, and aircraft sensors 28. In an embodiment, the command lines 24a and 24b, and feedback lines 26a and 26b may be a single line, or may be signals transmitted wirelessly. In an embodiment, APU controller 14 and door controller 16 are microcontrollers or computer processors and may be implemented using, for example, a field programmable gate array (FPGA). Although illustrated as a system for controlling an inlet door of an APU, in an embodiment system 10 may be implemented to control an inlet door of any gas turbine engine. The door controller 16 may be integrated into the door actuator 18 as a single component. Aircraft sensors 28 sense flight conditions such as, for example, speed, wind conditions, altitude and temperature and provide these conditions as input to aircraft control system 22. In an embodiment, the flight conditions or other parameters are sent through the aircraft data bus from, for example, an aircraft engine controller. These flight conditions may be communicated to APU controller 14 from aircraft control system 22 using a communication link utilizing any aircraft communication protocol known in the art, or may be communicated directly from the sensors 28. Aircraft control system 22 is any aircraft control system known in the art, and is implemented external to APU 12.

Inlet door 20 is opened to, and held at an intermediate position prior to cranking of APU 12 to limit airflow to the engine. When starting an APU in flight, for example, air coming into the engine through inlet door 20 can vary quite drastically based upon conditions such as the speed or altitude of the aircraft. This makes starting an APU in flight an unpredictable process. By opening to, and holding inlet door 20 at an intermediate position during startup, the airflow to APU 12 is controlled to better facilitate light-off of the engine based upon flight conditions.

The intermediate position of inlet door 20 may be fixed for a given application, or may be determined in-flight based upon flight conditions provided by aircraft control system 22. In an embodiment, these conditions are measured by aircraft system controller 22 and are not measured by APU 12 itself. In an alternate embodiment, APU 12 may measure the conditions itself, or the conditions may be measured by a combination of APU 12 and aircraft system controller 22. APU controller 14 uses the flight conditions and/or other APU start factors to determine the proper intermediate position for inlet door 20 using, for example, a lookup table or real-time algorithm based on aircraft parameters. This intermediate position may be any position between closed and fully open, such as 15°. Flight parameters include the speed of the aircraft, altitude of the aircraft, wind conditions, and outside temperature. Additional APU start factors may include the exhaust temperature of APU 12, the rotational speed of APU 12, or a combination of APU start factors.

In an embodiment, inlet door 20 is operated by door controller 16 based upon commands received from APU controller 14. These commands include, among others, a “door open” command and “stop door” command, or a specific position command. Door controller 16 receives these commands and operates door actuator 18 to move, or stop moving inlet door 20, or to move inlet door 20 to a specific position. In an additional embodiment, door controller 16 monitors the current position of inlet door 20 and provides feedback of the position of inlet door 20 to APU controller 14. In this way, APU controller 14 can monitor the position of inlet door 20 while the door is in motion.

In an alternate embodiment, door controller 16 receives the various flight conditions and/or additional APU start factors directly and calculates the position of inlet door 20 and controls door actuator 18 directly.

Inlet door 20 is controlled to open to an intermediate position for startup of APU 12 in order to better facilitate light-off. To initiate startup, a start command is sent to APU controller 14 from, for example, the cockpit of the aircraft. In an embodiment, the APU may initiate a startup sequence automatically when a power loss is detected.

In an embodiment, prior to initiating startup of APU 12, APU controller 14 will send door controller 16 a “door open” command. Door controller 16 recognizes the “door open” command and begins moving inlet door 20 into an open position. Door controller 16 monitors the position of inlet door 20 and provides feedback to APU controller 14 on feedback line 26a to indicate the present position of inlet door 20. When APU controller 14 receives feedback that inlet door 20 has reached the predetermined intermediate position, APU controller 14 sends door controller 16 a “stop door” command. When door controller 16 receives the “stop door” command, it operates door actuator 18 to stop moving and hold inlet door 20 at its present position.

Once inlet door 20 is in the intermediate position, APU controller 14 operates to start the light-off procedure of APU 12, which includes cranking, ignition, and fuel delivery. During light-off, APU controller 14 operates to accelerate APU 12 to a light-off speed using, for example, a starter motor. Inlet door 20 remains at the intermediate position until light-off of APU 12 is detected. APU controller 14 monitors the speed of APU 12 to determine when light-off has occurred. When APU 12 reaches a predetermined speed as observed by APU controller 14, light-off has occurred and APU 12 is accelerated up to a self-sustaining speed.

Following light-off, APU controller 14 operates to open inlet door 20 from the intermediate position to an optimal open position in order to provide a proper operational airflow to APU 12 when the APU is at full operating speed. APU controller 14 sends a “door open” command to door controller 16. Door controller 16 operates door actuator 18 to open inlet door 20 from the intermediate state to a more open state. Door controller 16 monitors the position of inlet door 20 and provides the position as feedback to APU controller 14 while inlet door 20 is in motion. When APU controller 14 detects that inlet door 20 is in an optimal open position, APU controller 14 sends a “stop door” command to door controller 16. Door controller 16 operates door actuator 18 to stop and hold inlet door 20 in the optimal open position. Opening inlet door 20 to a fully open position following startup of APU 12 allows the proper airflow for APU operation at full operating speed. APU 12 can experience troubles such as flameout if inlet door 20 is left at an intermediate position during operation of APU 12.

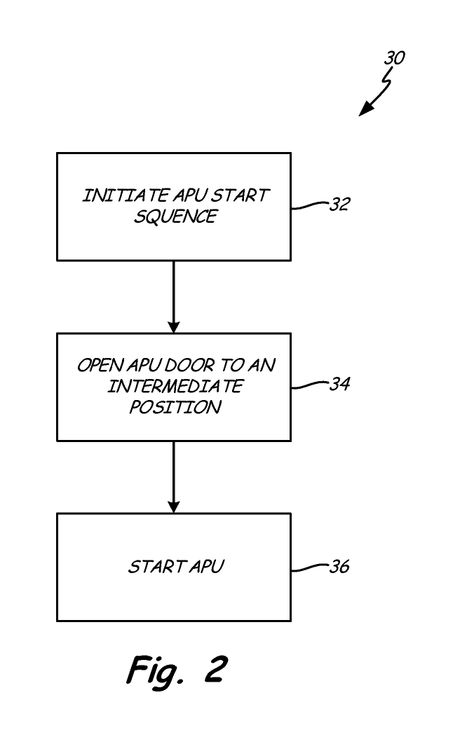

FIG. 2 is a flowchart illustrating a process flow 30 for starting an APU according to an embodiment. At block 32, a start sequence is initialized. In an embodiment, the start sequence may be initialized by a signal from the cockpit sent either manually by a pilot, or automatically based on one or more events. In an alternate embodiment, the APU initialization sequence may start automatically based on the detection of a loss of power, or some other system failure. At block 34, the APU inlet door 20 is opened to an intermediate position between fully closed and fully opened. At block 36, the APU 12 is started.

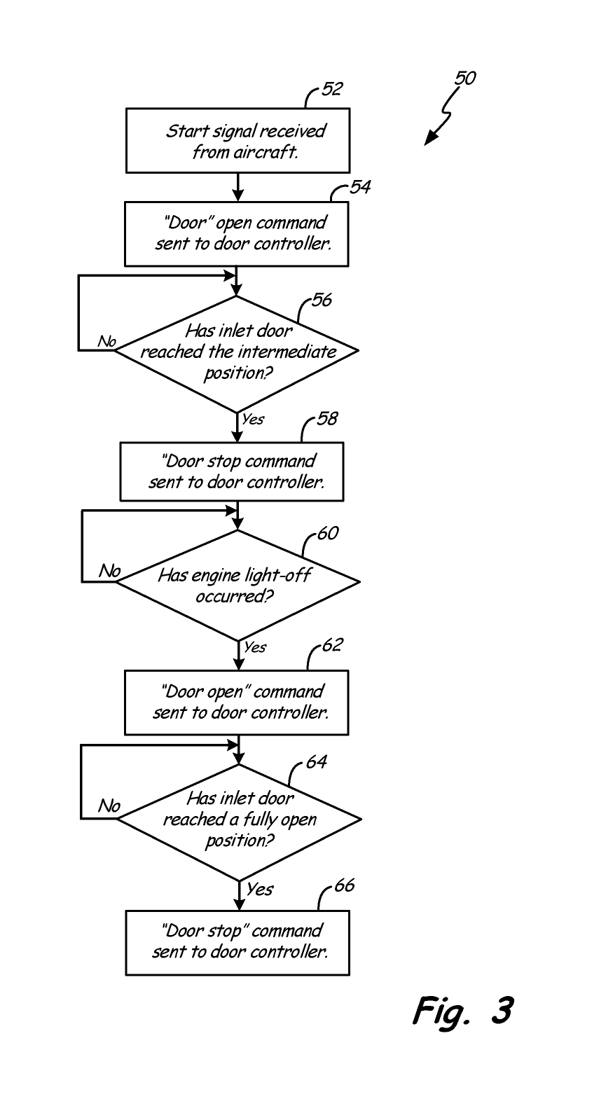

FIG. 3 is a flowchart illustrating a process flow 50 of controlling inlet door 20 of APU 12 as part of the APU initialization described above with regard to FIG. 2, according to an embodiment. At step 52, APU controller 14 receives an external start command from, for example, the cockpit of the aircraft. At step 54, APU controller 14 sends a “door open” command to door controller 16. Method 50 remains at step 56 until door controller 16 has indicated to APU controller 14 that inlet door 20 has reached the intermediate position. At step 58, APU controller 16 sends a “door stop” command to door controller 16 in order to stop and hold inlet door 20 at the intermediate position. Method 50 then waits at step 60 until the speed of the APU reaches a value indicative of light-off, such as 35% of the maximum APU speed. At step 62, APU controller 14 sends a “door open” command to door controller 16. Door controller 16 operates door actuator 18 to set inlet door 20 in motion from the intermediate position to a more open position. Method 50 remains at step 64 until door controller 16 has indicated to APU controller 14 that inlet door 20 is at a fully open position. At step 66, APU controller 14 sends a “door stop” command to door controller 16. Door controller 16 operates door actuator 18 to stop and hold inlet door 20 at a fully open position for the remainder of APU operation.

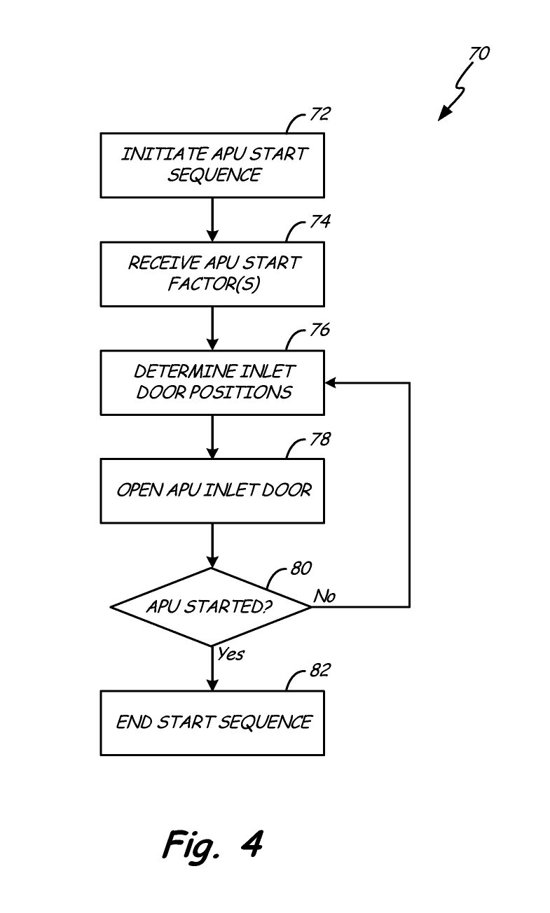

FIG. 4 is a flowchart illustrating a process flow 70 of controlling inlet door 20 of APU 12 as part of the APU initialization described above with regard to FIG. 2 according to an alternate embodiment. At block 72 an APU initialization sequence is started. At block 74, an APU controller receives one or more APU start factors. At block 76, the inlet door position is determined based on one or more APU start factors. In an embodiment, the inlet door position is determined by an algorithm that calculates an inlet door position based on, for example, air speed and altitude. In an additional embodiment, the inlet door position is determined by one or more APU start factors that are internal to the APU 12 such as engine rotation speed, engine temperature, etc. In an additional embodiment, the inlet door position is determined based on a combination of internal and external APU start factors. In yet another embodiment, the APU inlet door position is chosen from a table made up of two or more dimensions based on one more start factors.

At block 78, the APU inlet door 20 is opened to a position based on the determined position. In an additional embodiment, APU controller 14 transmits a digital or analog signal to door controller 16 that indicates the exact position to open the inlet door 20. In an embodiment, door controller 16 sends a signal to the door actuator 18 for a period of time corresponding to the amount of time required to open inlet door 20 to the determined position. In an additional embodiment, door controller 16 sends one or more discrete digital or analog signals that cause inlet door actuator 18 to open inlet door 20 to the determined position.

At block 80, it is determined if APU 12 has started. In an embodiment, APU controller 14 determines if APU 12 has started based on one or more of: the engine rotation speed; the temperature of the air exiting APU 12, the temperature of one or more components of APU 12, or any other method known in the art. If APU 12 has not started, then processing continues at block 76 where the position of APU inlet door 20 is determined once more using one or more of the methods described above. In an embodiment, the position of APU inlet door 20 is determined and then opened or closed to the newly determined position substantially constantly until APU 12 has started. In an embodiment, a different algorithm or table may be used to calculate the APU inlet door position based on a range of one or more APU start factors. For example, in an embodiment, a first algorithm may be used to calculate the APU door inlet position while the aircraft is under 8,000 feet of altitude, a second algorithm may be used between 8,000 feet and 10,000 feet of altitude, and a third algorithm may be used above 10,000 feet. In an embodiment, any number of different algorithms may be used, and one or more of the algorithms may be selecting a value from one or more multi-dimensional tables.

At block 82, if APU 12 has started, the start sequence ends. In an embodiment, once the start sequence ends APU inlet door 20 is opened completely. In an embodiment, the position of APU inlet door 20 may continue to be adjusted after APU 12 has started, and until APU 12 is fully operational. In yet another embodiment, one or more algorithms may be used to continuously adjust the position of inlet door 20 even after APU 12 is fully operational in order to maximize efficiency of APU 12.

The following are non-exclusive descriptions of possible embodiments of the present invention.

A gas turbine engine inlet door control system includes, among other things: an actuator for opening and closing an inlet door of a gas turbine engine, an engine controller for determining an intermediate door position based upon one or more engine start factors, and a door controller for operating the actuator to open the inlet door to the intermediate door position based on the one or more engine start factors.

The system of the preceding paragraph can optionally include, additionally and/or alternatively, any one or more of the following features, configurations and/or additional components:

The engine controller is configured to send a command to the door controller. The command is configured to instruct the door controller to open the door.

The door controller is configured to provide feedback to the engine controller indicating a current position of the inlet door.

The command is a start command configured to instruct the door controller to begin opening the door, and the engine controller is further configured to send a stop command to the door controller upon the current position of the inlet door being equal to the intermediate door position.

The open command includes a discrete instruction that includes the intermediate door position, and the door controller is configured to open the door to the intermediate position included in the discrete instruction.

The door controller is configured to open the inlet door to, and hold the inlet door at a fully open position following light-off of the gas turbine engine.

The door controller is configured to continuously adjust the inlet door position based on a change of one or more of the engine start factors.

Light-off of the gas turbine engine is detected by the engine controller based upon detecting one of: a predetermined speed of the gas turbine engine; and an exhaust temperature of the gas turbine engine.

The engine start conditions include one or more aircraft flight conditions. The system further includes aircraft sensors for sensing the one or more aircraft flight conditions and providing the aircraft flight conditions to an aircraft control system. The aircraft control system provides the aircraft flight conditions to the engine controller.

A system for starting a gas turbine engine includes, among other things: a computer processor configured to: determine an intermediate door position for an inlet door based on a gas turbine initialization signal, open the inlet door to the intermediate door position, and start the gas turbine engine.

The system of the preceding paragraph can optionally include, additionally and/or alternatively, any one or more of the following features, configurations and/or additional components:

The computer processor is further configured to continue opening the inlet door from the intermediate position to a fully opened position based on determining that the gas turbine engine has reached a speed indicative of a light-off.

The intermediate door position is determined based on one or more start factors.

A position of the inlet door is adjusted substantially constantly until light-off of the gas turbine engine has occurred.

The computer processor is one of: a gas turbine engine controller, and an inlet door controller.

The one or more start factors include: speed of the aircraft, altitude of the aircraft, air temperature, exhaust gas temperature, rotational speed of the gas turbine engine, air flow entering the inlet door, air pressure, and oxygen content of air entering the inlet door.

The intermediate door position is determined using a plurality of algorithms chosen based on one or more of the start factors.

The intermediate door position is determined based on a multidimensional table of predetermined door positions.

The computer processor is further configured to substantially continuously adjust the inlet door position after the gas turbine engine is fully started.

A method of controlling an inlet door of a gas turbine engine includes, among other things: receiving one or more engine start factors following initiation of a start sequence, determining an intermediate position for the inlet door based upon the one or more engine start factors, opening the inlet door of the gas turbine engine to the intermediate position, and starting the gas turbine engine.

The method of the preceding paragraph can optionally include, additionally and/or alternatively, any one or more of the following features, configurations and/or additional components:

The method further includes opening the inlet door to a more open position following detection of light-off of the gas turbine engine.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A gas turbine engine inlet door control system comprising:
an actuator for opening and closing an inlet door of a gas turbine engine;
an engine controller for determining an intermediate door position based upon one or more engine start factors; and
a door controller for operating the actuator to open the inlet door to the intermediate door position based on the one or more engine start factors.

2. The system of claim 1, wherein the engine controller is configured to send a command to the door controller, the command configured to instruct the door controller to open the door.

3. The system of claim 2, wherein the door controller is configured to provide feedback to the engine controller indicating a current position of the inlet door.

4. The system of claim 3, wherein the command is a start command configured to instruct the door controller to begin opening the door, and the engine controller is further configured to send a stop command to the door controller upon the current position of the inlet door being equal to the intermediate door position.

5. The system of claim 2, wherein the open command includes a discrete instruction that includes the intermediate door position, and the door controller is configured to open the door to the intermediate position included in the discrete instruction.

6. The system of claim 1, wherein the door controller is configured to open the inlet door to, and hold the inlet door at a fully open position following light-off of the gas turbine engine.

7. The system of claim 1, wherein the door controller is configured to continuously adjust the inlet door position based on a change of one or more of the engine start factors.

8. The system of claim 5, wherein light-off of the gas turbine engine is detected by the engine controller based upon detecting one of:
a predetermined speed of the gas turbine engine; and
an exhaust temperature of the gas turbine engine.

9. The system of claim 6, wherein the engine start conditions include one or more aircraft flight conditions, and further comprising aircraft sensors for sensing the one or more aircraft flight conditions and providing the aircraft flight conditions to an aircraft control system, wherein the aircraft control system provides the aircraft flight conditions to the engine controller.

10. A system for starting a gas turbine engine, the system comprising:
a computer processor configured to:
determine an intermediate door position for an inlet door based on a gas turbine initialization signal;
open the inlet door to the intermediate door position; and
start the gas turbine engine.

11. The system of claim 10, wherein the computer processor is further configured to continue opening the inlet door from the intermediate position to an optimal position based on determining that the gas turbine engine has reached a speed indicative of a light-off.

12. The system of claim 10, wherein the intermediate door position is determined based on one or more start factors.

13. The system of claim 12, wherein a position of the inlet door is adjusted substantially constantly until light-off of the gas turbine engine has occurred.

14. The system of claim 10 wherein the computer processor is one of:
a gas turbine engine controller; and
an inlet door controller.

15. The system of claim 12, wherein the one or more start factors include:
speed of the aircraft;
altitude of the aircraft;
air temperature;
exhaust gas temperature;
rotational speed of the gas turbine engine;
air flow entering the inlet door;
air pressure; and
oxygen content of air entering the inlet door.

16. The system of claim 12, wherein the intermediate door position is determined using a plurality of algorithms chosen based on one or more of the start factors.

17. The system of claim 10, wherein the intermediate door position is determined based on a multidimensional table of predetermined door positions.

18. The system of claim 10, wherein the computer processor is further configured to substantially continuously adjust the inlet door position after the gas turbine engine is fully started.

19. A method of controlling an inlet door of a gas turbine engine, the method comprising:
receiving one or more engine start factors following initiation of a start sequence;
determining, by a computer processor, an intermediate position for the inlet door based upon the one or more engine start factors;
opening the inlet door of the gas turbine engine to the intermediate position; and
starting the gas turbine engine.

20. The method of claim 19, further comprising opening the inlet door to a more open position following detection of light-off of the gas turbine engine.
